(19) United States
(12) Patent Application Publication
(10) Pub. No.: US 2005/0041965 A1
(43) Pub. Date: Feb. 24, 2005

(54) Image pickup device and method for manufacturing the same

(75) Inventor: Takahiko Morozumi, Kumagaya-shi (JP)

Correspondence Address: Finnegan, Henderson, Farabow,;Garrett & Dunner, L.L.P., 1300 I Street, N.W., Washington, DC, 20005-3315, US

(73) Assignee: KABUSHIKI KAISHA TOSHIBA

(21) Appl. No.: 10/916,415

(22) Filed: Aug. 12, 2004

(30) Foreign Application Priority Data
Aug. 22, 2003 (JP) 2003-298723

(51) Int. Cl. G03B 17/00

(52) U.S. Cl. 396/427

(57) ABSTRACT

An image pickup device has a unit having a camera element which can be moved in a tilt direction inside thereof, and having two first engaging portions outside thereof, and a base having two second engaging portions which are plastically deformed and fixed, the base engaging these engaging portions with the two first engaging portions, respectively, thereby movably supporting the unit in a pan direction, wherein a tilt unit can be easily and precisely mounted on the base.

### CROSS-REFERENCE TO RELATED APPLICATIONS

This application is based upon and claims the benefit of priority from prior Japanese Patent Application No. 2003-298723, filed Aug. 22, 2003, the entire contents of which are incorporated herein by reference.

### BACKGROUND OF THE INVENTION

1. Field of the Invention

The present invention relates to an image pickup device having a tilt unit movably mounted on a base and a method for manufacturing the image pickup device.

2. Description of the Related Art

In recent years, with the spread of digital equipment, various types of image information equipment such as a digital camera have been developed and manufactured. As such image information equipment, an image pickup device used for, for example, a monitor camera is known. In such an image pickup device, a camera unit is driven by means of a motor or the like, whereby an image is picked up at a viewing angle which is as wide as possible.

As such a prior art, patent document 1 (Jpn. Pat. Appln. KOKAI Publication No. 2001-238101) has a camera cover unit formed in a hemispheric dome shape, and this camera cover unit has a camera which moves the inside of the cover unit. In addition, this camera cover unit itself rotates at 360 degrees, for example, and an image can be picked up at a wide viewing angle.

However, in the above-described device, for example, where the device is mounted on a wall side face, when the camera cover unit is rotated so as to pick up an image in a wide field of view, a horizontal direction cannot be maintained. Thus, a natural field of view cannot be obtained such that a human being looks the inside of a room. Further, there is a problem that a specific configuration of a pan tilt mechanism for obtaining a natural field of view is not shown, and a configuration and a manufacturing method for mounting a tilt unit on a base efficiently and with high precision is not shown.

### BRIEF SUMMARY OF THE INVENTION

According to one aspect of the present invention, there is provided an image pickup device, comprising: a unit having a camera element which can be moved in a tilt direction inside thereof, and having two first engaging portions outside thereof; and a base having two second engaging portions which are plastically deformed and fixed, the base engaging these portions with the two first engaging portions, respectively, thereby movably supporting the unit in a pan direction.

### BRIEF DESCRIPTION OF THE SEVERAL VIEWS OF THE DRAWING

FIG. 1 is a front view showing an example of a tilt unit and a base of an image pickup device according to the present invention;

FIG. 2 is a side view illustrating an example of mounting the tilt unit and base of the image pickup device according to the invention;

FIG. 3 is a side view illustrating an example of mounting the tilt unit and base of the image pickup device according to the invention;

FIG. 4 is a sectional view illustrating an example of the tilt unit of the image pickup device according to the invention;

FIG. 5 is a perspective view showing an example of the tilt unit and base of the image pickup device according to the invention;

FIG. 6 is a bottom view showing an example of the tilt unit and base of the image pickup device according to the invention;

FIG. 7 is a sectional view showing an example of the tilt unit in the image pickup device according to the invention;

FIGS. 8A and 8B are top views showing an example of a pivot receiving portion provided at the tilt unit of the image pick device according to the invention;

FIGS. 9A and 9B are sectional views showing an example of the base and a pivot of the image pickup device according to the invention;

FIG. 10 is a side view illustrating another example of mounting the tilt unit and base of the image pickup device according to the invention;

FIG. 11 is an external view showing an example of an external view of the image pickup device according to the invention; and

FIG. 12 is a block diagram depicting an example of an electrical configuration of the image pickup device according to the invention.

### DETAILED DESCRIPTION OF THE INVENTION

Hereinafter, one embodiment of an image pickup device according to the present invention will be described with reference to the accompanying drawings.

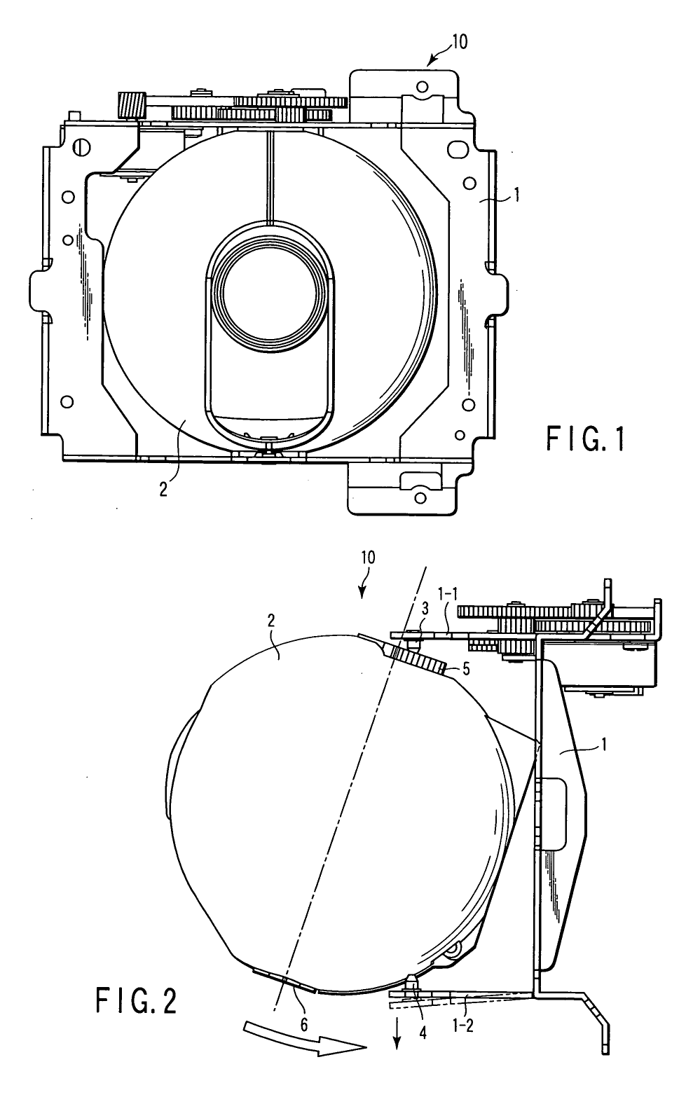

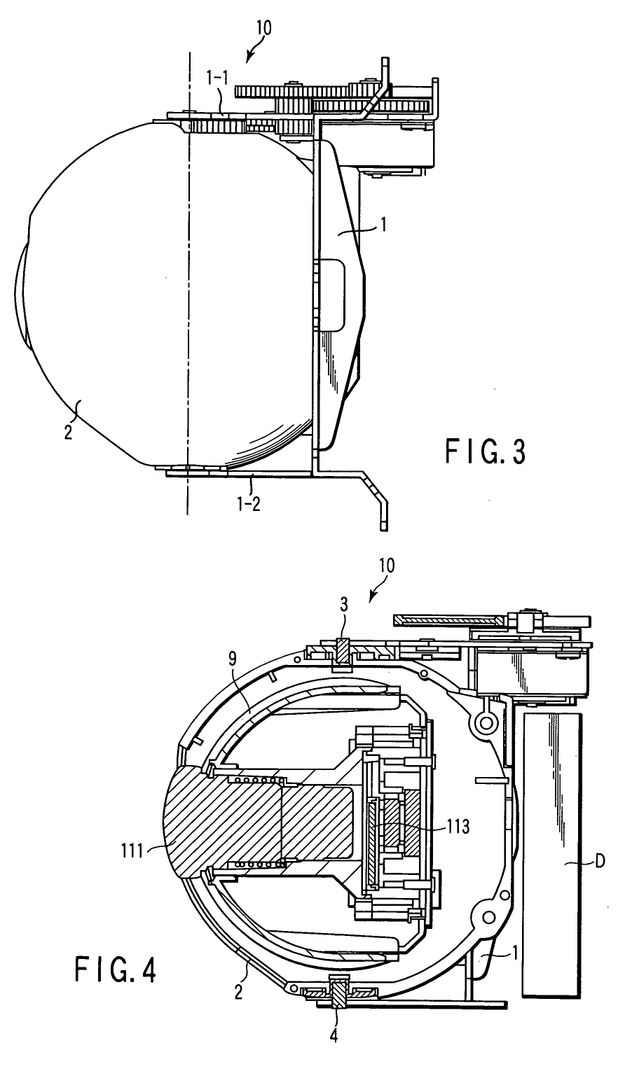

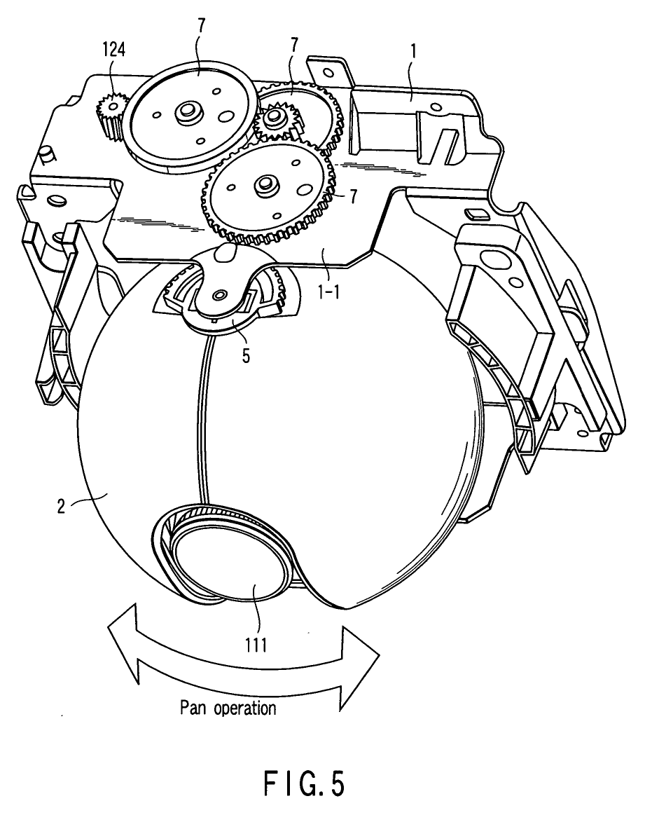

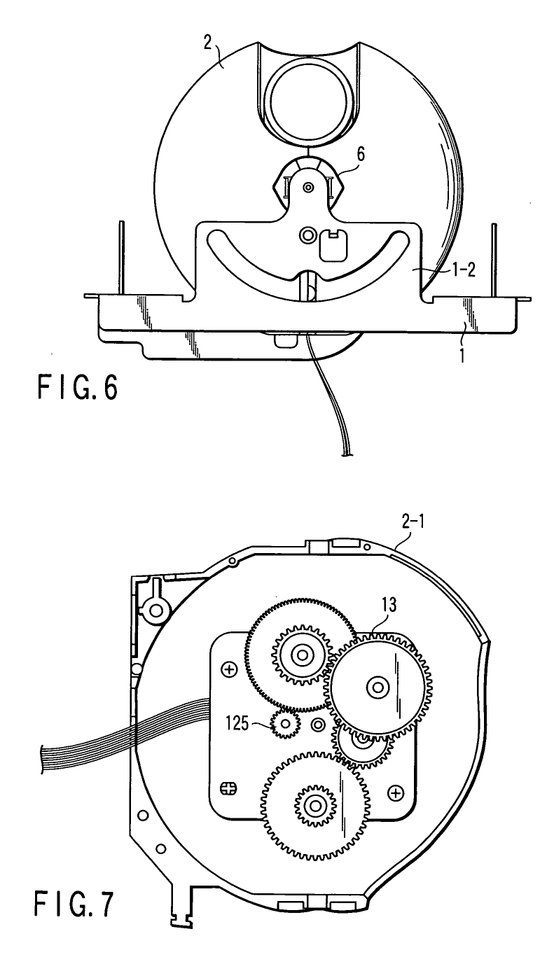

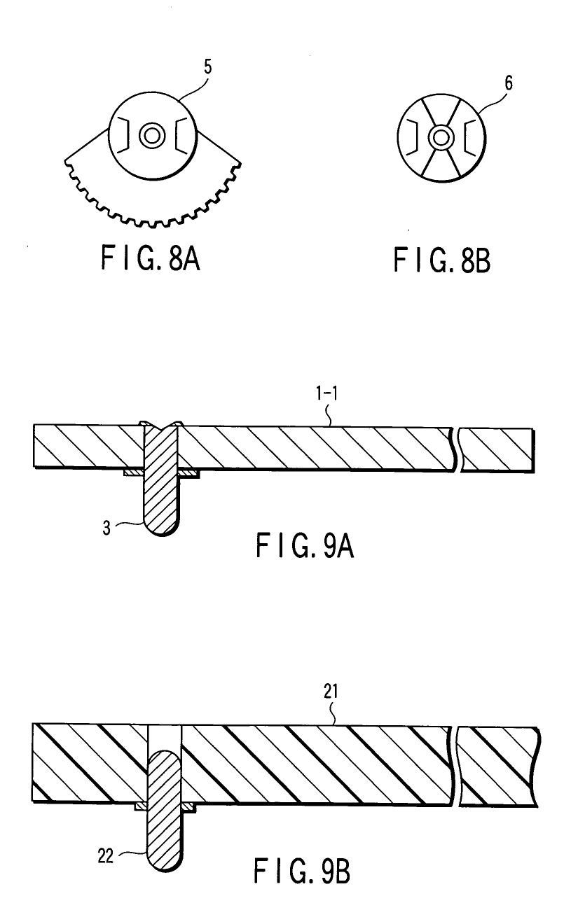

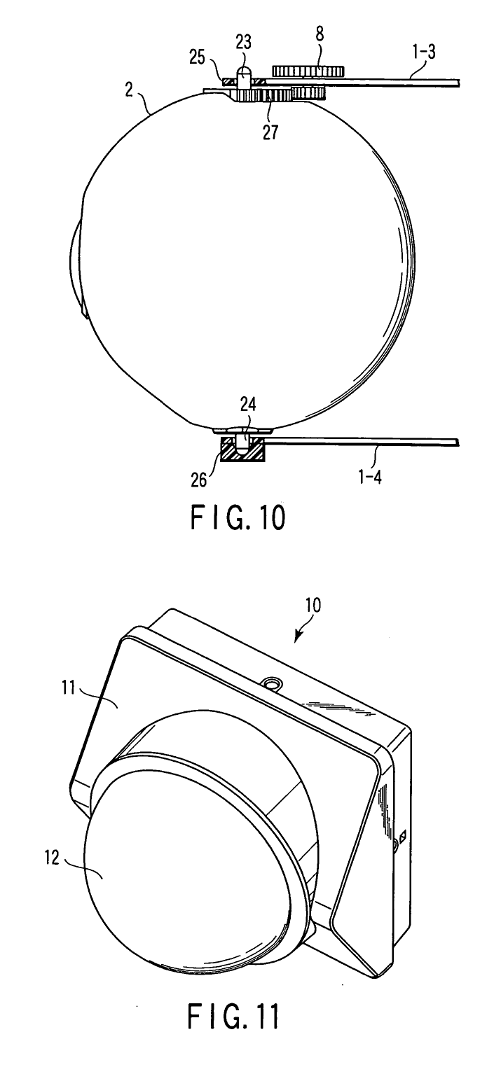

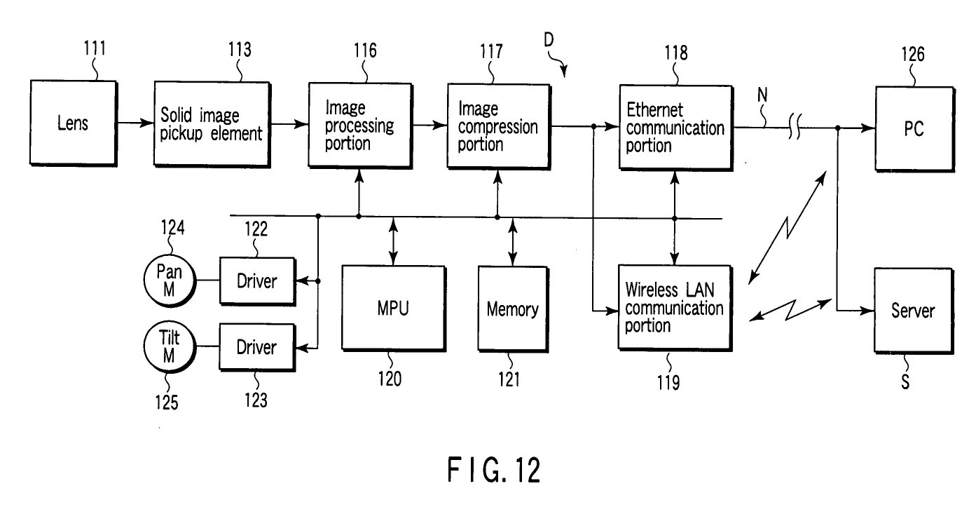

FIG. 1 is a front view showing an example of a tilt unit and a base of an image pickup device according to the present invention. FIGS. 2 and 3 are side views illustrating an example of mounting the tilt unit and base of the image pickup device according to the invention. FIG. 4 is a sectional view illustrating an example of the tilt unit of the image pickup device according to the invention. FIG. 5 is a perspective view showing an example of the tilt unit and base of the image pickup device according to the invention. FIG. 6 is a bottom view showing an example of the tilt unit and base of the image pickup device according to the invention. FIG. 7 is a sectional view showing an example of the tilt unit in the image pickup device according to the invention. FIGS. 8A and 8B are top views showing an example of a pivot receiving portion provided at the tilt unit of the image pick device according to the invention. FIGS. 9A and 9B are sectional views showing an example of the base and a pivot of the image pickup device according to the invention. FIG. 10 is a side view illustrating another example of mounting the tilt unit and base of the image pickup device according to the invention. FIG. 11 is an external view of the image pickup device according to the invention. FIG. 12 is a block diagram depicting an example of an electrical configuration of the image pickup device according to the invention.

(Base and Tilt Unit)

The image pickup device according to the present invention, as shown in these figures, comprises: a pan mechanism for moving camera units 111, 113 in a pan direction; and a tilt mechanism for moving the camera units 111, 113 in a tilt direction, whereby a natural wide field of view can be obtained. That is, in FIGS. 1 and 3, an image pickup device 10 according to the present invention comprises a base 1 serving as a fundamental structure of each mechanism and a tilt unit 2 mounted and supported on the base.

Further, the base 1, as shown in FIG. 5, comprises a pan motor 124 and a plurality of gears 7 transmitting rotation of the pan motor 124. In addition, the tilt unit 2 is connected to this gear 7, and the tilt unit 2 is driven in an arbitrary pan direction by means of rotation of the pan motor 124. The base 1 has a shape such that the plurality of gears 7 are mounted as is without requiring parts for mounting the gears.

Here, in the present invention, in the base 1, for example, pivots 3, 4 are provided as engaging portions for supporting the tilt unit 2 on the base 1. The pivots 3, 4 are plastically deformed and fixed (so called, caulked) by a specific executive machine tool without screwing the pivots. Further, the base 1 is made of a metal such as steel, and has predetermined elasticity. When assembled by a worker, arm portions 1-1 and 1-2 which are protrusion portions can be easily slackened as shown in FIG. 2. On the other hand, in the tilt unit 2 as well, for example, pivot receiving portions 5, 6 are provided as engaging portions, respectively. Therefore, as shown in FIG. 2, when assembled by the worker, the base 1 is slackened and mounted in elastic deformation without screwing the pivots or the like.

In the image pickup device 10 according to the present invention, the tilt unit 2 is assembled to be slackened in elastic deformation on the base 1 having such features, whereby the working process is reduced and facilitated as compared with a case of screwing or the like. In addition, with respect to the pivots of the base 1 as well, a specialist for forming the base 1 can be plastically deformed and fixed (so called, caulked), whereby the base can be rigidly formed at a precise mount location. Thus, even if the worker is a skilled worker, the tilt unit 2 can be mounted on the base 1 easily and with high precision.

Here, with respect to elasticity of the base, as an example, it is preferable that the base 1 should indicate slackness of 5 mm or more with a force of 5 Kg or less. That is, it is required to provide elasticity of providing slackness according to a pivot length which constantly functions in a range such a worker having ordinary ability can carry out a work easily. However, this numeric value is provided as an example, and, of course, a similar operation and advantageous effect is achieved in similar gist with other values.

As a configuration preferred for achieving slackness, as shown in FIGS. 2, 3, 5 and 6, it is preferable that the base 1 has arm portions 1-1 and 1-2 as protrusion portions. That is, a pivot which is provided as an example of an engaging portion is fixed to the arm portions 1-1 and 1-2 serving as the protrusion portions of the base 1. In this manner, during mounting, slackening of the arm portions 1-1 and 1-2 will suffice, and the required elastic deformation can be easily achieved.

In addition, as shown in FIG. 11, the image pickup device according to the present invention comprises a cover 11 and a transparent dome shaped cover 12 as an example, and protects the above-described mechanism.

(Tilt Unit)

Next, the tilt unit 2 will be described in detail with reference to the accompanying drawings. The tilt unit 2 comprises a tilt mechanism inside the tilt unit, as shown in FIG. 4. This tilt unit can drive in a tilt direction a camera unit having a solid image pickup element 113 such as a lens 111 and a CCD. That is, as shown in the sectional view of FIG. 7, the tilt unit 2-1 comprises a plurality of gears for transmitting rotation of a tilt motor 115 provided on the base 13 of the tilt mechanism. This tilt unit can control a direction of a camera unit connected to this gear.

Further, as an example, this tilt unit 2 comprises pivot receiving portions 5, 6 as shown in FIGS. 8A and 8B, respectively, as engaging portions. Here, in the pivot receiving portion 5, gears are integrated with each other, and a pivot receiving function and a gear function are provided.

(System Configuration and Operation)

Here, an operation of an image pickup device serving as a system will be described with respect to a block diagram of an electrical package D of FIG. 12. In FIG. 12, as an example, an image pickup device 10 that is a network camera comprises: a lens 11; and a solid image pickup element 113 such as a CCD (Charge Coupled Device) for receiving incident light that passes the lens and outputting a detection signal according to this incident light. Further, the image pickup device 10 comprises: an image processing portion 116 for receiving an output from the solid image pickup element 113 as an electrical package portion D shown in FIG. 4; and an image compression portion 117 for carrying out compression processing such as MPEG compression or JPEG compression for the image-processed image signal. At the image processing portion 116, image processing functions such as, for example, sharpness processing, contrast processing, Gamma correction, while balance processing, and pixel adding processing are applied to the inputted image signal.

Furthermore, the image pickup device 10 comprises an MPU (Main Processing Unit) 120, and a memory 121. The MPU (Main Processing Unit) 120 controls whole processing operation and controls transmission or the like of log information which is a feature of the present invention described later. The memory 121 provides a work area for storing a program which governs these operations and for carrying out processing operations for an image signal, and stores therein screen data or the like for alarm indication.

Moreover, the image pickup device 10, as the electrical package portion D, is connected to the MPU 120 via a data bus. This image pickup device has an Ethernet communication portion 118, and a wireless LAN (Local Area Network) communication portion 119, and carries out communication with, for example, an external PC 126 or a server S via a wired network or a wireless network.

The image pickup device 10, as the electrical package portion D, also has a pan driver 122 for driving a camera unit C in a pan direction, the pan driver being connected to the MPU 120 via a data bus and controlled; and a tilt driver 123 for driving the camera unit C in a tilt direction. These drivers are connected to a pan motor 124 such as a stepping motor described above and a tilt motor 125 such as a stepping motor. Furthermore, the camera unit C comprises at least the above-described lens 111 and solid image pickup element 113.

The image pickup device 10 that is a network camera having such a configuration carries out basic operation as described below. That is, the image pickup device 10 can carry out: an image pickup operation for receiving incident light from an object and supplying an image signal according to an image pickup screen thereof via a network or the like; a camera drive operation for driving a direction of the camera unit C in, for example, a pan direction or a tilt direction, and further, a variety of setting operations for setting an operating mode (for example, mask processing) or a mask region based on the picked-up image signal, and a self test operation, etc.

That is, in the image pickup operation, a command signal is received from the PC 126 or the like that is a control device, via a network N (or wireless network). This pickup operation is carried out under the control of the MPU 120 according to the operating program stored in the memory 121. The solid image pickup element 113 having received incident light from an object via the lens 111 supplies a detection signal according to the incident light to the image processing portion 116. After predetermined image processing has been applied, the image compression portion 117 carries out image compression such as JPEG compression or MPEG compression. The detection signal is outputted to the outside via the Ethernet communication portion 118 or the wireless LAN communication portion 119.

In the camera drive operation, after zero coordinate adjustment has been made in the pan motor 124 and the tilt motor 125 which are stepping motors, the MPU 120 always recognizes the direction of the current camera unit C. In this manner, the MPU 120 always manages the coordinate of a screen that is picked up by the current camera unit C. According to an operation control signal supplied from the MPU 120 to a driver, the camera unit C is driven in the pan direction or tilt direction, and an image pickup screen changes. At the same time, the MPU 120 always recognizes the coordinate of the current image pickup screen. Therefore, a user can move the camera unit C in the pan direction or tilt direction while looking at the image pickup screen according to an image signal which the current image pickup device 10 continuously supplies from a screen of the PC 126 or the like connected to a network and can look at the image pickup screen according to the movement. In addition, the MPU 120 recognizes and manages the coordinate of the current image pickup screen, and the user can also acquire the coordinate information of the current image pickup screen on the PC 126, for example, according to operation.

Further, in each of the operating modes, for example, in a mask processing mode, predetermined mask processing is applied for an image in an arbitrary region set by the user. That is, mask processing operations are carried out, such that, when the mask region in the image pickup screen is set, for example, mosaic processing is then applied to the mask region in the image pickup screen according to the user operation during a predetermined period; filling operation is carried out with a black image; or one image is replaced with another image.

(Other Embodiments)

Furthermore, a base 1 of an image pickup device 1 according to the present invention may be produced with a resin such as a plastic 21, as shown in FIG. 9B, according to another embodiment. At this time, FIG. 9A shows production of the above-described base 1 using a metal such as a steel. A pivot 3 is shown as being plastically deformed and fixed (so called, caulked) by a specific machine tool. On the other hand, if the base 21 is produced with the resin 21 such as a plastic, it is generally preferable that the thickness of the base be greater than a base made of metal. Further, a pivot 22 may be inserted into the base 21 instead of being plastically deformed and fixed (so called, caulked).

Moreover, FIG. 10 shows that pivot receiving portions 25, 26 are provided on the base 1, and pivots 23, 24 are provided on the tilt unit 2. Here also, the operation and advantageous effect similar to those of the above-described embodiment are achieved. Similarly, arm portions 1-3 and 1-4 are provided, and slackness is easily achieved. In the pivot 23, a coaxial gear is provided at the side of the tilt unit 2 of the pivot 23, enabling drive operation in the stable pan direction of the tilt unit 2. Furthermore, the similar operation and advantageous effect of an engaging portion are provided for any portion other than pivots and pivot receiving portions.

According to embodiments described above, one skilled in the art can carry out the present invention. Further, various modifications of these embodiments can be easily conceived by one skilled in the art, and application to a variety of embodiments is possible even if one skilled in the art has no inventive ability. Therefore, the present invention covers a broad range which is not contradictory to the disclosed principle and novel features, and is not limited to the above-described embodiments.

1. An image pickup device comprising:
a unit having a camera element which can be moved in a tilt direction inside thereof, and having two first engaging portions outside thereof; and
a base having two second engaging portions which are plastically deformed and fixed, the base engaging these engaging portions with the two first engaging portions, respectively, thereby movably supporting the unit in a pan direction.

2. An image pickup device according to claim 1, wherein the base is plastically deformed, thereby making it possible to engage the first engaging portion of the unit with the second engaging portion of the base.

3. An image pickup device according to claim 1, wherein the two second engaging portions are provided at two protrusion portions of the base, and the two protrusion portions are elastically deformed, thereby making it possible to engage the first engaging portion of the unit with the second engaging portion of the base.

4. An image pickup device according to claim 1, wherein the first engaging portion is a pivot receiving portion, and the second engaging portion is a pivot.

5. An image pickup device according to claim 1, wherein the first engaging portion is a pivot, and the second engaging portion is a pivot receiving portion.

6. An image pickup device according to claim 1, wherein the first engaging portion is a pivot receiving portion having a gear integrated therewith, and the second engaging portion is a pivot.

7. An image pickup device according to claim 1, wherein the base has a shape such that a gear can be mounted as is without requiring parts.

8. An image pickup device according to claim 1, wherein the base is made of a metal.

9. An image pickup device according to claim 1, wherein the base is made of a resin.

10. An image pickup device according to claim 1, wherein a pan motor to move the unit in a pan direction is provided on the base, and a tilt motor to move the camera element in a tilt direction is provided in the unit.

11. A method for manufacturing an image pickup device, comprising:
providing a unit having a camera element which can be moved in a tilt direction inside thereof, and having two first engaging portions outside thereof; and
elastically deforming a base having two second engaging portions which are plastically deformed and fixed, thereby engaging the two engaging portions with the two first engaging portions of the unit, respectively, and movably supporting the unit in a pan direction.

12. A method for manufacturing an image pickup device, according to claim 11, wherein the two second engaging portions are provided at two protrusion portions of the base, and the two protrusion portions are elastically deformed, thereby engaging the first engaging portion of the unit with the second engaging portion of the base.

13. A method for manufacturing an image pickup device, according to claim 11, wherein the first engaging portion is a pivot receiving portion, and the second engaging portion is a pivot.

14. A method for manufacturing an image pickup device, according to claim 11, wherein the first engaging portion is a pivot, and the second engaging portion is a pivot receiving portion.

15. A method for manufacturing an image pickup device, according to claim 11, wherein the first engaging portion is a pivot receiving portion having a gear integrated therewith, and the second engaging portion is a pivot.

16. A method for manufacturing an image pickup device, according to claim 11, wherein the base is formed in a shape such that a gear can be mounted as is without requiring parts.

17. A method for manufacturing an image pickup device, according to claim 11, wherein the base is made of a metal.

18. A method for manufacturing an image pickup device, according to claim 11, wherein the base is made of a resin.

19. A method for manufacturing an image pickup device, according to claim 11, wherein a tilt motor to move the camera element in a tilt direction is mounted in the unit, and a pan motor to move the unit in a pan direction is mounted on the base.

20. A method for manufacturing an image pickup device, according to claim 11, wherein the image pickup device further comprises:
a unit having a camera element which can be moved in a tilt direction inside thereof, and having two first engaging portions outside thereof; and
a base having two second engaging portions, the base being elastically deformed to engage the first engaging portion of the unit with the second engaging portion of the base, thereby movably supporting the unit in a pan direction.
